(19) United States
(12) Patent Application Publication
(10) Pub. No.: US 2026/0264458 A1
(43) Pub. Date: Sep. 10, 2026

(54) TIRE TREAD FOR A HEAVY GOODS VEHICLE COMPRISING STONE-EXPELLING AND NOISE-PREVENTING PROJECTIONS

(71) Applicant: COMPAGNIE GENERALE DES ETABLISSEMENTS MICHELIN, Clermont-Ferrand (FR)

(72) Inventors: BENJAMIN QUANTINET, Clermont-Ferrand (FR); ARNAUD LARREGAIN, Clermont-Ferrand (FR)

(21) Appl. No.: 19/163,582

(22) PCT Filed: Mar. 4, 2024
(86) PCT No.: PCT/EP2024/055562

§ 371 Date: Sep. 9, 2025

(30) Foreign Application Priority Data
Mar. 9, 2023 (FR) FR2302165

(51) Int. Cl. B60C 11/13

(52) U.S. Cl. CPC B60C 11/1353; B60C 2011/1361; B60C 2200/06

(57) ABSTRACT

The subject of the present invention is a tyre of which at least one longitudinal furrow (6) comprises a longitudinal distribution of protuberances (7), which is transverse from a depression (72) in the wall (61, 62) of the furrow. Each protuberance has a free end (71) positioned at a transverse distance d1 from the opposite lateral wall (61, 62) of the furrow at least equal to 0.4 times the mean width W of the furrow (6). The height H′ of the free end is at least equal to 0.7 times the depth H of the longitudinal furrow (6). Each protuberance (7) has, at its free end (71), a longitudinal thickness L1 at least equal to 1 mm. Each protuberance (7) is positioned facing a portion of lateral wall (61, 62) without a protuberance (7).

The present invention relates to a tyre tread and to a tyre for a heavy-duty vehicle intended to carry heavy loads and to run on stony ground or on tarmacked ground, and, more particularly, to a tyre tread for a construction plant vehicle of the mobile crane type, which is intended to move from one construction site to another in order to lift heavy loads, in particular for tyres in which the radius of the nominal rim is equal to 22.5 inches.

A tread comprises at least one rubber-based material and is intended to constitute the peripheral part of a tyre and to be worn away when its tread surface comes into contact with the ground.

A tread can be defined by three dimensions: a depth, in a radial direction, a width, in a transverse direction, and a length, in a longitudinal direction. When a tread is incorporated into the tyre, the transverse direction is also referred to as the axial direction since it is parallel to the axis of rotation of the tyre, and the longitudinal direction is also referred to as the circumferential direction since it is tangential to the circumference of the tyre along the running direction of the tyre.

To ensure in particular satisfactory performance in terms of longitudinal grip, under engine torque and under braking torque, and in terms of transverse grip, it is necessary to form, in the tread, a tread pattern that is a more or less complex system of cuts, or voids, separating elements that are raised with respect to a bottom surface.

In the case of a tyre tread for a heavy-duty construction plant vehicle, the raised elements are generally ribs or blocks. A raised element is a volume of rubber material delimited by a contact face, which is contained in the tread surface, by a bottom surface, and by lateral faces that connect the contact face to the bottom surface. A rib is a circumferential raised element delimited by two adjacent longitudinal voids, also referred to as longitudinal furrows or, more simply, as furrows; adjacent is understood to mean that there is no longitudinal furrow between two adjacent furrows. Blocks are raised elements having a circumferential length shorter than the circumferential length of the tyre, usually shorter than a circumferential length of the contact patch measured at nominal pressure and under nominal load. Blocks can be arranged so as to form longitudinal rows of blocks, these rows being separated in pairs by longitudinal furrows. A longitudinal void has a mean line that is not necessarily rectilinear, having at each point a tangent that forms an angle of between 0° and 45° with the longitudinal direction. Furthermore, within one and the same longitudinal row of blocks, the blocks are usually separated in pairs by transverse voids. A transverse void has a mean line that is not necessarily rectilinear, having at each point a tangent that forms an angle of between 0° and 45° with the transverse direction. Thus, the respectively longitudinal and transverse voids form a network of cuts separating the blocks.

The tread of a tyre is usually characterized geometrically by a transverse width of the tread, along the transverse direction, and a radial depth, along a radial direction. The transverse width of the tread is defined as being the transverse width of the contact area of the tread of the new tyre with smooth ground, such as tarmacked ground, when the tyre is subjected to nominal pressure and load conditions recommended, for example, by the “European Tyre and Rim Technical Organization” or E.T.R.T.O. standard. The radial depth is defined, by convention, as being the maximum radial depth measured in the voids, corresponding to the maximum radial block height. In the case of a tyre for a construction plant vehicle of the mobile crane type, and by way of example, the transverse width of the tread is at least equal to 300 mm and the radial thickness is at least equal to 12 mm.

The normal running conditions of a tyre for a heavy-duty vehicle of the mobile crane type are generally mixed, both off-road, on stony ground, and on-road, on tarmacked ground.

When the tyre is running on stony ground, its tread is likely to retain stones in its longitudinal and transverse voids, and in particular at the zones of intersection between a longitudinal void and a transverse void. These stones retained by the voids of the tread are then likely to create perforations in the tread, which can cause damage to the crown reinforcement of the tyre, which is radially on the inside of the tread, and, ultimately, breakage of said crown reinforcement rendering the tyre unusable. Devices for ejecting stones, in the form of protuberances of suitable shape and size, are described in the documents EP 3178669, WO 0132448 and WO 2009082394.

When the tyre is running on tarmacked ground, at higher speed, its tread is likely to generate noise, in particular because of the presence of longitudinal voids in which airborne sound waves propagate. Devices for damping these sound waves, which are usually referred to as anti-noise devices, often in the form of flexible obstacles forming an at least partial barrier in the longitudinal voids, are described in the documents WO 2013171172 and WO 2012001031.

When used on tarmacked ground, at higher speed, the tyres also need to allow proper evacuation of any water that may be present on the road. Specifically, unlike purely off-road vehicles, cranes can run at 80 km/h on an asphalted road. Anti-noise barriers in the furrows represent an obstacle to this evacuation and can impair grip on wet ground.

The inventors set themselves the objective of improving, for a tyre in particular for a heavy-duty vehicle for mixed use on a construction site on non-asphalted ground and on a road, its capacity to not retain stones in its voids, during use on construction sites, its capacity to dampen the noise that it generates, during use on a road, and its capacity to evacuate water when running on-road on wet ground.

This objective was achieved by a tyre for a vehicle, comprising a tread, which is intended to come into contact with the ground via a tread surface and comprises cuts delimiting raised elements extending from a bottom surface along a radial direction,
at least one cut being a longitudinal furrow, which is delimited by two facing lateral walls that are connected together by a furrow bottom, and extends along the entire circumferential length L of the tread along a longitudinal direction (XX′),
each longitudinal furrow having a depth H, which is measured between the tread surface and the furrow bottom along a radial direction (ZZ′), and a mean width W, which is measured between the two lateral walls in the tread surface along a transverse direction (YY′),
at least one longitudinal furrow comprising a longitudinal distribution of protuberances,
each protuberance extending transversely from a depression in a wall of the longitudinal furrow towards the opposite wall of said furrow, the depression having a longitudinal length LA along a longitudinal direction (XX′) and a transverse width TA along the transverse direction (YY′) towards the interior of the longitudinal furrow,
each protuberance having a free end positioned at a transverse distance d1 from the opposite lateral wall of the furrow at least equal to 0.4 times the mean width W of the longitudinal furrow,
each protuberance extending radially outwards from the furrow bottom over a height H′, at its free end, at least equal to 0.7 times the depth H of the longitudinal furrow,
each protuberance having, at its free end, a longitudinal thickness L1 at least equal to 1 mm,
each protuberance being positioned facing a portion of lateral wall without a protuberance.

Essentially, the tread according to the invention comprises, in at least one longitudinal furrow, a longitudinal distribution of protuberances, each protuberance extending from a depression that is able to contain water in order to compensate for the presence of the protuberance with regard to the storage of water in the furrow. This protuberance has the anti-noise barrier function. An anti-noise barrier contributes to the damping of the airborne sound waves propagating in the longitudinal furrow when the tyre is running on tarmacked ground. To be effective, this protuberance needs to have a height H′ at least equal to 0.7 times the depth H of the longitudinal furrow in which it is positioned. The free end of these protuberances does not have a particular stiffness function, but it is necessary for it to be resistant when running on stony ground, and so the free end of the protuberances needs to have a longitudinal thickness L1 at least equal to 1 mm. Since the objective of the invention is for these protuberances to function while maintaining grip performance on wet ground, it is necessary for them not to impair the flow of water in the furrow. Thus, the protuberance must not protrude into the furrow over more than 60% of the mean width W of the furrow. The mean width W will be measured on the new tyre which is free at the tread surface and away from the portions provided with protuberances and the depressions thereof. Likewise, in order not to impair the flow of water in the furrow, the region of the furrow opposite the protuberance and the depression thereof must not contain a protuberance which could have a negative effect on the flow of water in the furrow. Thus, each protuberance is positioned facing a portion of lateral wall without a protuberance. This portion without a protuberance has an equivalent longitudinal length at least equal to the longitudinal length LA of the depression from which the protuberance extends. Its limits correspond to the projections orthogonal to the walls of the furrows of the longitudinal ends of the depression.

The depth H of the furrow is the maximum depth measured between the tread surface and the radially innermost point of the furrow bottom, in the longitudinal mean plane of the longitudinal furrow. The height H′ of the protuberance corresponds to a maximum height of the protuberance from the void bottom from which the height H is measured. The height of the protuberance can vary in the transverse and/or longitudinal directions. A protuberance height H′ at least equal to 0.7 times the depth H of the longitudinal furrow is intended to ensure the presence of the protuberance over almost the entire depth of the furrow, for good anti-noise barrier effectiveness.

A depression in a furrow forms a void in the wall of a furrow. Between two adjacent protuberances and their associated depressions, away from the cuts, the furrows usually form rectilinear or wavy repeating patterns. It is easy for a person skilled in the art to perceive the repeating pattern of the furrow, its waviness, and therefore to perceive the start and end of a depression associated with a protuberance with, in particular, the transitional regions between the furrow and its longitudinal walls and the walls of the depression forming an angle substantially different from at least 30° with respect to the wall of the furrow. If the junction between the walls of the furrow and those of the depression is a sharp edge, the longitudinal length LA of the depression will be measured between the sharp edges. If this junction is formed by the connecting radius of a rounded portion, the longitudinal length LA of the depression will be such that half the length of the rounded portion will be considered to form part of the furrow and the other half will be considered to form part of the depression. The transverse width of the depression will be measured between the straight line connecting the two longitudinal ends of the depression and the farthest away point of the wall of the depression. These measurements will be taken at the tread surface.

Since the objective of the depression is to compensate for the presence of the protuberance in half of the furrow, a preferred solution is that the longitudinal length LA of the depression of each protuberance is at least equal to 0.7 times the mean width W of the furrow and at most equal to 1.3 times the mean width W of the furrow.

According to the same principle, an advantageous solution is that the transverse width TA of the depression of each protuberance is at least equal to 0.2 times the mean width W of the furrow and at most equal to 0.8 times the mean width W of the furrow.

These values of LA and TA allow a good balance between the stiffness of the raised element, the volume of rubber to be worn away for the wear performance and the volume of voids for storing water when running on wet ground.

The depression has to free up the space for storing water. Therefore, it must not be mainly filled by the volume of the protuberance. Thus, each protuberance has a mean longitudinal thickness L1M at most equal to 50% of the longitudinal length LA of the depression, preferably at most equal to 20% of the longitudinal length LA of the depression. The mean longitudinal thickness L1M is the average of the measurements of the longitudinal thickness of the protuberance in the radially outermost part of each protuberance, between two transverse ends thereof from its free end to as close as possible to the two following points: either its other transverse ends or the point of the protuberance that is situated at a transverse distance equal to W-d1 from the free end. In the case of a continuous protuberance crossing the raised element, the thickness of the protuberance at the raised element has no influence on the performance aspects of the protuberance at the furrow.

A depression creates a void in a wall of a furrow, thereby creating two parts in the wall of this furrow on either side of the depression. The depression itself has a wall connecting the two parts of the wall of a furrow and also the tread surface at the bottom of the furrow. This connection can be brought about by a substantially radial wall for maximizing the volume of the depression and its capacity to store water. However, such a configuration presents two problems. The first is that this void is likely to store gravel, which can crack the bottom of the furrow as far as the first metal or textile reinforcing elements of the tyre, exposing them to the effect of the water present on the underlying ground, this having a negative effect on the endurance of the tyre. The second problem is that the void creates a stiffness differential on the raised element, and this can generate uneven wear. To remedy these problems, it is advantageous for each depression to be connected to the furrow by inclined walls that form a mean angle B with the radial direction (ZZ′), and for the mean angle B to be at most equal to 65°. The angle B depends finally on the furrow width and on the transverse width TA of the depression. According to the invention, it is important that the walls of the depression, when they are inclined, do not form an obstacle to the flow of water in the furrow and are therefore such that their height as a most zero at the wall opposite the protuberance. For this purpose, the angle B should be at most equal to the arctangent of (W+TA)/H.

An inclined wall in the depression allows a more gradual transition of the stiffness of the raised element and therefore makes it possible to limit uneven wear at the depression. These inclined walls also prevent stones from passing too far into the tread pattern and thus act as stone ejectors. A stone ejector has the function of promoting the ejection of stones retained in the voids, when the tyre is running on stony ground, and of preventing them from attacking the furrow bottom.

For an optimal effect in relation to noise, a preferred solution is that each protuberance of the longitudinal furrow extends radially over a height H′ at least equal to 90% of the depth H of the longitudinal furrow.

The protuberances bear against one or the other of the lateral walls, and two consecutive protuberances, along the longitudinal direction, which do not necessarily bear against the same lateral wall, are spaced apart by a spacing P, the longitudinal distance between said two protuberances.

All the geometric characteristics described are measured on a tyre tread when new.

According to a preferred embodiment, the protuberances of the longitudinal furrow alternately bear against one or the other of the lateral walls. This alternate positioning of the protuberances on one and the other of the walls means that two consecutive protuberances do not bear against the same wall, but are in contact with facing walls. This alternation ensures almost complete closure of the longitudinal furrow, by overlapping of the protuberances positioned on facing walls, and therefore an almost total barrier to the propagation of sound waves. Given the flow rate of the water and its viscosity, this disposition does not constitute an obstacle to the evacuation of water in the contact patch and therefore allows good grip.

Advantageously, the protuberances of the longitudinal furrow are spaced apart in pairs by a pitch P at most equal to 0.1 times the circumferential length L of the tread. Bearing in mind that, when the tyre is subjected to nominal load and pressure conditions, the contact patch in which the tread is in contact with the ground has a longitudinal length of around 0.1 times the length L of the tread, this condition implies the presence of at least two protuberances in the contact patch closing the longitudinal furrow in the contact patch and thereby avoiding the formation of a pipe, between the tread and the ground, which is likely to generate noise. Note that the spacing P between two consecutive protuberances is not necessarily constant.

In the particular case of a tyre comprising at least one transverse groove, an advantageous solution is that said at least one transverse groove connects two depressions of two protuberances of two adjacent longitudinal furrows delimiting a raised element. In this case, the volume of the transverse groove is added to the volume of depression, allowing better storage and better circulation of water in the contact patch. In such a case, the transverse width TA of the depression will be at most the width of the raised element in the case of a transverse groove of deepest depth. If the transverse groove is not of deepest depth, there is a wall of the depression that provides the transition between the furrow bottom and the raised bottom of the groove, which will allow the transverse depth TA of the depression to be calculated.

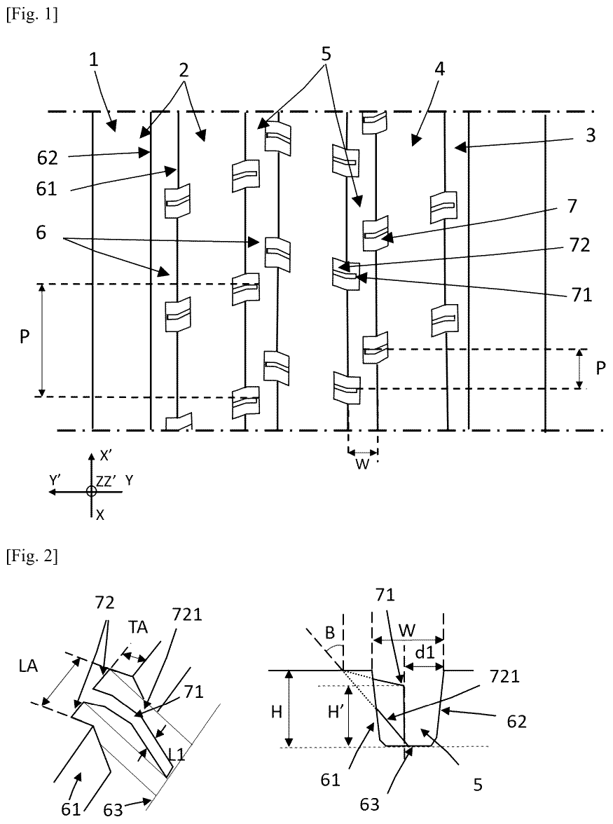

The features of the invention are illustrated in the schematic FIGS. 1 to 5, which are not drawn to scale:

FIG. 1: Top view of a portion of a tread according to the invention,

FIG. 2: Perspective view of a protuberance of a longitudinal furrow of a tread according to the invention, and cross-sectional view of a protuberance of a longitudinal furrow of a tread according to the invention with an angle B of around 45°,

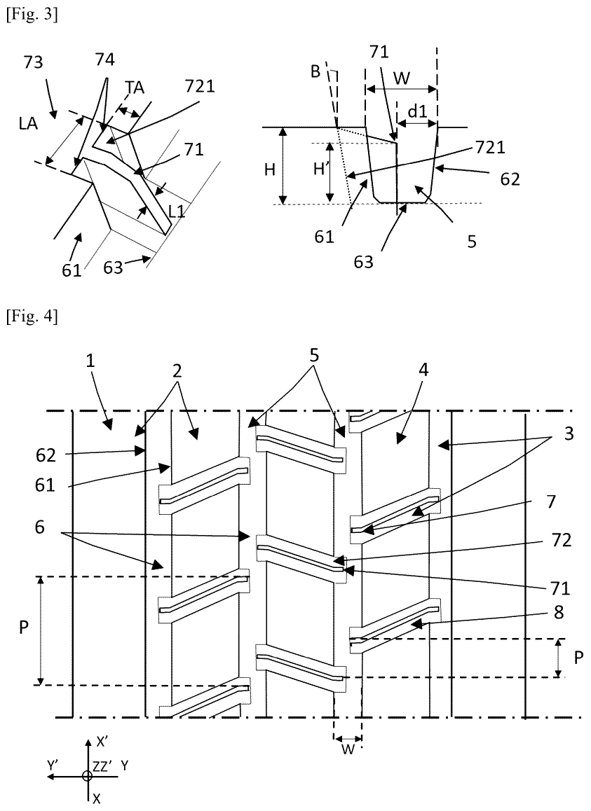

FIG. 3: Perspective view of a protuberance of a longitudinal furrow of a tread according to the invention, and cross-sectional view of a protuberance of a longitudinal furrow of a tread according to the invention with an angle B of around 5°,

FIG. 4: Top view of a portion of a tread comprising transverse grooves according to the invention,

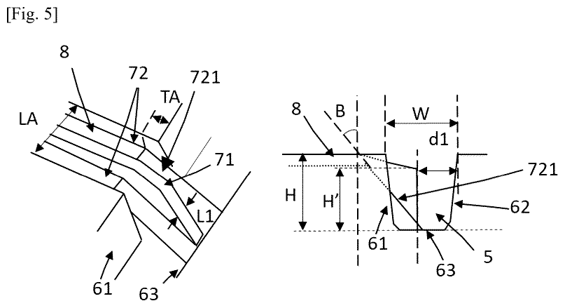

FIG. 5: Perspective view of a protuberance of a longitudinal furrow of a tread comprising transverse grooves according to the invention, and cross-sectional view of a protuberance of a longitudinal furrow of a tread comprising transverse grooves according to the invention with an angle B of around 45°.

FIGS. 1 and 4 are top views of a portion of a tread 1 according to the invention. The tyre tread 1 for a heavy-duty vehicle, which is intended to come into contact with the ground via a tread surface 2, comprises cuts 3 delimiting raised elements 4 made of rubber that extend from a bottom surface 5 along a radial direction ZZ′. Cuts 3 in the tread 1 are either longitudinal furrows 6 of mean width W or transverse voids 8 that are present only in FIG. 4. In the embodiment shown, of the four longitudinal furrows 6, which are each delimited by two facing lateral walls 61 and 62 that are connected together by a furrow bottom 63, and which extend along the entire length of the tread 1 along a longitudinal direction XX′, each furrow comprises a longitudinal distribution of protuberances 7 bearing alternately against one and the other of the lateral walls 61 or 62, two consecutive protuberances positioned respectively on two facing lateral walls 61 and 62 being spaced apart by a spacing P. The spacing P is variable, but this is not a necessary feature of the invention. Each protuberance 7 is positioned in a depression 72 and has a free end 71. Each protuberance 7 is positioned facing a portion of lateral wall 61, 62 without a protuberance 7.

FIG. 4 differs therefrom in that transverse grooves 8 link two depressions 72 of two protuberances 7 of two adjacent longitudinal furrows 6 delimiting a raised element 4.

FIGS. 2, 3 and 5 show a perspective view of a protuberance 7 of a longitudinal furrow 6 of a tread according to the invention and a cross-sectional view of a protuberance 7 of a longitudinal furrow 6 of a tread according to the invention. The protuberance 7 of the longitudinal furrow 6 of depth H extends transversely from a depression 72 in a wall 61, 62 of the longitudinal furrow 6 towards the opposite wall of said furrow, the depression 72 having a longitudinal length LA along the transverse direction XX′ and a transverse width TA, along the transverse direction YY′ towards the interior of the longitudinal furrow. Each protuberance comprises a free end 71, extending radially outwards from the furrow bottom 63 positioned on the bottom surface 5 at a height H′. Each free end 71 is positioned at a transverse distance d1 from the opposite lateral wall of the furrow, at least equal to 0.4 times the mean width W and preferably at most equal to 0.6 times the mean width W. This makes it possible to set the compromise between the performance in terms of noise, for which the distance d1 needs to be at a minimum, and the performance in terms of grip on wet ground, for which the distance d1 needs to be at a maximum.

The free end 71 has a thickness L1 and the protuberance 7 has a mean thickness L1M which are depicted as being equal in the figures. Each depression 72 is connected to the furrow 6 by inclined walls 721 that form a mean angle B with the radial direction ZZ′. B is around 45° in FIGS. 2 and 5 and around 5° in FIG. 3. FIG. 5 illustrates a possible version of the invention when a transverse groove 8 connects two depressions on either side of the raised element 4.

The inventors have more particularly studied this invention for a tyre of size 445/75R22.5 intended to be mounted on a specific type of mobile crane, comprising a tread having a tread pattern with anti-noise and stone-ejecting protuberances, in accordance with the invention. According to the ETRTO standard, such a tyre has to be capable of bearing a load at least equal to 6000 kg when it is inflated to a pressure at least equal to 8 bar. This size is ultimately intended to bear a load of 6500 kg for a pressure of 9 bar, and therefore needs to comply with the associated standards.

For the tyre according to the invention, the depth H of the furrow is equal to 15 mm, H′ being equal to H, and its width W is equal to 16 mm. The free ends of the protuberances are located at a distance d1 from the opposite wall equal to 7.8 mm. The thickness L1 of the free end of the protuberance is equal to 2.2 mm, and its mean thickness L1M is equal to 1.5 mm. The length LA of the depression is 17.1 mm for a depth TA of 8.6 mm, and it continues as a transverse groove with a depth of 4 mm, meeting another depression in the same raised element on the adjacent furrow. The walls 712 of the depression make an angle B equal to 55° with the direction ZZ′. The protuberances 7 of the longitudinal furrow 6 alternately bear against one or the other of the lateral walls of the longitudinal furrow with a minimum spacing equal to 27 mm.

The tyre of the example studied has an outside diameter equal to 1238 mm, this corresponding to a developed tread length L equal to 3885 mm. The tread comprises, in each of its longitudinal furrows and along its entire length L, 96 anti-noise and stone-ejecting protuberances that are alternately positioned on the facing walls of the longitudinal furrow, constituting 48 pairs of protuberances forming 48 anti-noise barriers. When this tyre is inflated to a pressure equal to 9 bar and subjected to a load equal to 6500 kg, the contact patch of its tread contains, for a given longitudinal furrow, 3 pairs of protuberances, each forming an anti-noise barrier extending over almost the entire width of the longitudinal furrow.

The tyre complies with the so-called “coast-by” noise standard of regulation R117 of the European Union. According to expert knowledge, the protuberance allows an improvement of 1 dB(A). Note that the tyres for a crane of larger size do not need to comply with this type of standard.

Furthermore, the tyre complies with the “wet grip” standard of regulation R117 of the European Union.

1-10. (canceled)

11. A tire for a vehicle, comprising a tread, which is intended to come into contact with a ground via a tread surface and which comprises cuts delimiting raised elements extending from a bottom surface along a radial direction,
wherein at least one cut is a longitudinal furrow, which is delimited by a first lateral wall and a second lateral wall that are facing each other and connected to each other by a furrow bottom, and which extends along an entire circumferential length L of the tread along a longitudinal direction,
wherein the longitudinal furrow has a depth H, which is measured between the tread surface and the furrow bottom along a radial direction, and a mean width W, which is measured between the first and second lateral walls in the tread surface along a transverse direction,
wherein the longitudinal furrow comprises protuberances distributed in the longitudinal direction,
wherein each protuberance extends transversely from a depression in the first lateral wall of the longitudinal furrow towards the second lateral wall of the longitudinal furrow, the depression having a longitudinal length LA along the longitudinal direction and a transverse width TA along the transverse direction towards inside the longitudinal furrow,
wherein each protuberance has a free end that is positioned at a transverse distance d1 from the second lateral wall of the longitudinal furrow at least equal to 0.4 times the mean width W of the longitudinal furrow,
wherein each protuberance extends radially outwards from the furrow bottom over a height H′, at the free end of the protuberance, at least equal to 0.7 times the depth H of the longitudinal furrow,
wherein each protuberance has, at the free end of the protuberance, a longitudinal thickness L1 at least equal to 1 mm, and
wherein each protuberance is positioned facing a portion of the second lateral wall, which is free of protuberance.

12. The tire according to claim 11, wherein the longitudinal length LA of the depression of each protuberance is at least equal to 0.7 times the mean width W of the longitudinal furrow and at most equal to 1.3 times the mean width W of the longitudinal furrow.

13. The tire according to claim 11, wherein the transverse width TA of the depression of each protuberance is at least equal to 0.2 times the mean width W of the longitudinal furrow and at most equal to 0.8 times the mean width W of the longitudinal furrow.

14. The tire according to claim 11, wherein each protuberance has a mean longitudinal thickness L1M at most equal to 50% of the longitudinal length LA of the depression.

15. The tire according to claim 11, wherein the transverse distance d1 is at most equal to 0.6 times the mean width W of the longitudinal furrow.

16. The tire according to claim 11, wherein each depression is connected to the longitudinal furrow by inclined walls that form a mean angle B at most equal to 65° with the radial direction.

17. The tire according to claim 11, wherein each protuberance of the longitudinal furrow extends radially over a height H′ at least equal to 90% of the depth H of the longitudinal furrow.

18. The tire according to claim 11, wherein the protuberances of the longitudinal furrow alternately bear against the first lateral wall and the second lateral wall of the longitudinal furrow.

19. The tire according to claim 11, wherein two consecutive protuberances, not necessarily bearing against the same first or second lateral wall, are spaced apart by a spacing P, and
wherein the protuberances of the longitudinal furrow are spaced apart in pairs by a spacing at most equal to 0.1 times the circumferential length L of the tread.

20. The tire according to claim 11, wherein the tread comprises at least one transverse groove, and
wherein the at least one transverse groove connects two depressions of two protuberances of two adjacent longitudinal furrows delimiting one of the raised elements.

21. The tire according to claim 11, wherein each protuberance has a mean longitudinal thickness L1M at most equal to 20% of the longitudinal length LA of the depression.

22. The tire according to claim 19, wherein the protuberances of the longitudinal furrow are spaced apart in pairs by a spacing at most equal to 0.05 times the circumferential length L of the tread.
